(19) United States
(12) Patent Application Publication
(10) Pub. No.: US 2010/0162399 A1
(43) Pub. Date: Jun. 24, 2010

(54) METHODS, APPARATUS, AND COMPUTER PROGRAM PRODUCTS THAT MONITOR AND PROTECT HOME AND SMALL OFFICE NETWORKS FROM BOTNET AND MALWARE ACTIVITY

(75) Inventors: Daniel Sheleheda, Florham Park, NJ (US); Cynthia Cama, Belmar, NJ (US)

Correspondence Address: AT&T Legal Department - MB;Attn: Patent Docketing, Room 2A-207, One AT&T Way, Bedminster, NJ, 07921, US

(73) Assignee: AT&T Intellectual Property I, L.P.

(21) Appl. No.: 12/338,468

(22) Filed: Dec. 18, 2008

(51) Int. Cl. G06F 12/14

(52) U.S. Cl. 726/24

(57) ABSTRACT

Methods, apparatus and computer program products that protect networks from malware and botnet activity include collecting xFlow data associated with a network, analyzing the collected xFlow data to detect anomalous traffic on the network, investigating the presence of malware on the network in response to detecting anomalous traffic on the network, and taking remedial action to eradicate and/or isolate malware detected on the network. Collecting xFlow data includes capturing xFlow data at a router that connects the network and a communications network, and sending the captured xFlow data to a local or remote xFlow collector. Analyzing collected xFlow data, locally or remotely, to detect anomalous traffic includes applying one or more activity profiling algorithms to the xFlow data.

### BACKGROUND

The present application relates generally to communications networks, and more particularly, to methods, apparatus and computer program products for protecting communications networks and devices connected to communications networks.

Communications networks are widely used for nationwide and worldwide communication of voice, multimedia and/or data. As used herein, communications networks include public communications networks, such as the Public Switched Telephone Network (PSTN), terrestrial and/or satellite cellular networks and/or the Internet.

The Internet is a decentralized network of computers that can communicate with one another via Internet Protocol (IP). The Internet includes the world wide web (web) service facility, which is a client/server-based facility that includes a large number of servers (computers connected to the Internet) on which web pages, applications and/or files reside, as well as clients (web browsers), which interface users with the remote servers. Specifically, web browsers and software applications send a request over the web to a server, requesting a web page identified by a Uniform Resource Locator (URL), which notes both the server where the web page resides and the file or files on that server which make up the web page. The request includes the IP address of the client. The server then sends a copy of the requested file(s) to the IP address associated with the client, and the web browser at the client terminal displays the web page to the user. Other types of interaction are possible. For example, a file can be requested from a remote file server, data can be requested from an application on a remote server, etc. In any such exchange, the remote server must be supplied with an address to which the response should be sent.

The topology of the web can be described as a network of networks, with providers of network services called Network Service Providers, or NSPs, or Internet Service Providers (ISPs). As used herein, the term Service Provider (SP) is intended to include NSPs and ISPs. Servers that provide application-layer services may be referred to as Application Service Providers (ASPs). Sometimes a single service provider provides both functions.

Malicious software, often referred to as “malware”, is a program or file that is harmful to a computer user. Malware includes, but is not limited to, computer viruses, worms, Trojan horses, and spyware, which is programming that gathers information about a computer user without permission. Spam is unsolicited e-mail on the Internet.

A botnet is a network of computers set up to forward transmissions, such as spam, viruses, worms, Trojan horses, spyware, etc., to other computers on the Internet, typically without the knowledge or authorization of the computer owners. An individual computer in a botnet is referred to as a “robot” or “bot”, and serves at the command of a master spam or malware originator. Computers that become bots in a botnet are often those whose owners fail to provide effective firewalls and/or other safeguards. An increasing number of home users have high speed connections for computers that may be inadequately protected. A bot is often created through an Internet port that has been left open and through which a small Trojan horse program can be left for future activation by a botnet controller. In addition, home and small office computers are increasingly becoming infected as a result of spamming and social engineering activities. For example, a user may receive an email with a link to a website. When the user activates the link and visits the website, his/her computer becomes infected. As such, a large percentage of malware and botnet traffic originates from home or small office computers.

Currently, antivirus software is the primary weapon in the battle against malware and botnet activity on home and small office networks. Unfortunately, antivirus software is often not able to detect new and polymorphic malware due to the signature-based detection methods of conventional antivirus software. As such, botnet activity may occur unabated until the malware signature is available.

### SUMMARY

Methods, apparatus and computer program products that monitor and protect home and small office networks against malware and botnet activity are provided. In some embodiments, a method of monitoring and protecting a private network, includes collecting xFlow data associated with the private network, analyzing the collected xFlow data to detect anomalous traffic on the private network, investigating the presence of malware on the private network in response to detecting anomalous traffic on the private network, and taking remedial action to eradicate and/or isolate malware detected on one or more computers on the network. In some embodiments, collecting xFlow data includes capturing xFlow data at a router that connects the private network to the communications network, and sending the captured xFlow data to a local xFlow collector on the private network. In other embodiments, collecting xFlow data includes capturing xFlow data at a router that connects the private network to the communications network, and sending the captured xFlow data to a remote xFlow collector connected to the communications network.

According to some embodiments, analyzing collected xFlow data to detect anomalous traffic on the private network includes applying one or more activity profiling algorithms to the xFlow data. According to some embodiments, investigating the presence of malware on the private network in response to detecting anomalous traffic on the private network may include one or more of the following: determining if a name of a file located on a computer on the private network has changed, determining if a registry entry on a computer on the private network has been modified, determining if one or more communications have occurred via specific ports and protocols (e.g., IRC, HTTP, SMTP, etc.), determining if software on a computer on the private network has attempted one or more network connections, determining if normal connectivity patterns have changed substantially, determining if one or more communications have occurred via specific IP addresses, and/or determining if significant change has occurred to normal traffic patterns.

In some embodiments, an apparatus configured to monitor and protect a network from botnet activity and malware, includes an xFlow data collector that collects xFlow data from the network, and a processor and memory that communicates with the xFlow data collector. The processor, which may be located locally on a private network or remotely on a communications network (e.g., at a SP location), is configured to analyze collected xFlow data, detect anomalous traffic on the private network, and identify malware residing on one or more devices connected to the network in response to detecting anomalous traffic on the network. The xFlow data collector collects xFlow data from a router associated with the network. The processor is configured to apply one or more activity profiling algorithms to the xFlow data to detect anomalous traffic. The processor is also configured to identify malware by: determining if a name of a file located on a computer on the private network has changed, determining if a registry entry on a computer on the private network has been modified, determining if one or more communications have occurred via specific ports and protocols (e.g., IRC, HTTP, SMTP, etc.), determining if software on a computer on the private network has attempted one or more network connections, determining if normal connectivity patterns have changed substantially, determining if one or more communications have occurred via specific IP addresses, and/or determining if significant change has occurred to normal traffic patterns.

In some embodiments, upon detecting anomalous traffic on a private network, an SP may redirect a network connection for the private network to a closed zone referred to as a “walled garden” so as quarantine the network connection. The walled garden may also be used as a “repair depot” wherein one or more anti-malware scanners can be run so as to identify malware. In addition, an image of suspected malware can be obtained and forwarded to an anti-virus vendor.

Advantageously, methods, apparatus, and computer program products described herein may provide significant benefits to home and small office network owners, to service providers, and to the Internet in general. The disruption of malicious botnets in home and small office networks may reduce network traffic on the local network, the service provider network, and on the Internet. The ability to squelch malicious traffic at the origin may reduce the scale of any DDOS (denial of service) attack where it is manageable. Early detection and mitigation may disable or slow the recruitment of new bots, which may reduce the scale problem of conventional botnets. Performance of home and small office computers and networks may be improved if they are not burdened with services demanded by bot controllers. Antivirus vendors may be able to identify new infections quicker and provide quicker signature detection and mitigation solutions.

Other methods, apparatus and/or computer program products according to exemplary embodiments will be or become apparent to one with skill in the art upon review of the following drawings and detailed description. It is intended that all such additional methods, apparatus and/or computer program products be included within this description, be within the scope of the present invention, and be protected by the accompanying claims.

### BRIEF DESCRIPTION OF THE DRAWINGS

The accompanying drawings, which form a part of the specification, illustrate some exemplary embodiments. The drawings and description together serve to fully explain the exemplary embodiments.

FIG. 1 is a block diagram that illustrates the topology of an exemplary home or small office network.

FIG. 2 is a block diagram that illustrates monitoring and protecting home and small office networks from botnet and malware activity, according to some embodiments.

FIG. 3 is a flow chart of operations for monitoring and protecting home and small office networks from botnet and malware activity, according to some embodiments.

FIG. 4 is a block diagram that illustrates details of an exemplary processor and memory that may be used to monitor and protect home and small office networks from botnet and malware activity, according to some embodiments.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification are taken to specify the presence of stated features, steps, operations, elements, and/or components, but do not preclude the presence or addition of one or more other features, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items and may be abbreviated as “/”.

As used herein, the term “malware” is intended to encompass and include all types of malicious and/or unwanted programs and code such as, but not limited to, spam, viruses, Trojan horses, worms, spyware, etc.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another.

Exemplary embodiments are described below with reference to block diagrams and/or flowchart illustrations of methods, apparatus (systems and/or devices) and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, exemplary embodiments may be implemented in hardware and/or in software (including firmware, resident software, micro-code, etc.). Furthermore, exemplary embodiments may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Python, Java, AJAX (Asynchronous JavaScript), C, and/or C++, for development convenience. In addition, computer program code for carrying out operations of exemplary embodiments may also be written in other programming languages, such as, but not limited to, interpreted languages. Some modules or routines may be written in assembly language or even micro-code to enhance performance and/or memory usage. However, embodiments are not limited to a particular programming language. It will be further appreciated that the functionality of any or all of the program modules may also be implemented using discrete hardware components, one or more application specific integrated circuits (ASICs), or a programmed digital signal processor or microcontroller.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

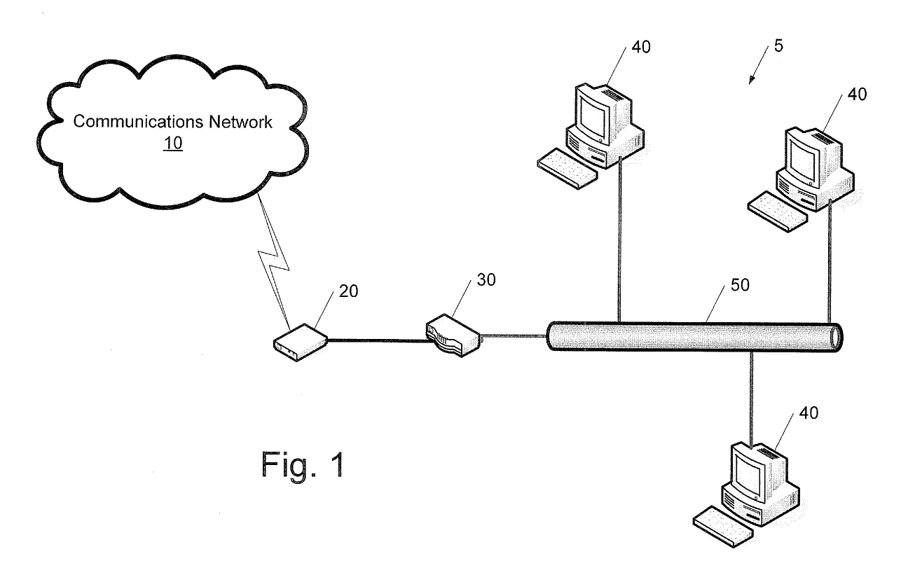

FIG. 1 illustrates an exemplary subscriber home or small office network 5. that includes a plurality of computers 40 networked together, for example, via Ethernet 50. Home or small office networks can have various configurations, can have various numbers of computers and devices connected thereto, and these computers and devices can be connected via various other local area network (LAN) technologies, including wireless LAN technologies.

The illustrated network 5 is linked to a communications network 10, such as the Internet, via e.g., a modem 20 (e.g., cable modem, DSL modem, etc.) for accessing the communications network 10. The subscriber (i.e., owner of the network 5) “subscribes” to connection services from a service provider (SP) that controls the communications network 10 (i.e., the subscriber pays the SP to connect to the communications network 10). It should be appreciated, however, that there may be authorized users of the network 5 other than the subscriber. In the illustrated embodiment, a residential gateway 30 is provided to share the DSL or cable modem connection with the computers 40 in the network 5. The residential gateway 30 is located between the DSL or cable modem 20 and the internal network 5. Alternately, the DSL or cable modem 20 might be integrated into the residential gateway 30, as one skilled in the art would understand. According to an exemplary embodiment, the residential gateway 30 includes a router or similar traffic director (e.g., a switch or other device). The router is configured to determine where data packets are to be forwarded so as to reach their destination on the communication network 10 and on the network 5. The router may also serve as a firewall for the network 5, as would be understood by those skilled in the art.

Many, if not most, homes and small offices utilize local or home area networks to provide multiple devices with connectivity to the Internet. Networking hardware has recently begun to support various xFlow protocols (e.g., network flow protocols such as rFlow, sFlow, etc.), which are designed to record network traffic metadata such as source and destination addresses, port protocols, and byte counts for each device connected to a network router. The metadata recorded by xFlow does not contain content and, thus, may not raise issues regarding the privacy of information flowing through a network. The term “xFlow”, as used herein, is intended to include all protocols configured to monitor network flow and record network traffic metadata.

A home/office network router implementing xFlow protocol generates an xFlow record for each “flow” through the router. A flow is generally defined as a unidirectional sequence of packets all sharing some or all of the following values: source IP address, destination IP address, source port (e.g., TCP port), destination port (e.g., TCP port), IP protocol, and IP type of service (e.g., HTTP, IRC, FTP, etc.). The router outputs a flow record when it determines that a flow is finished (e.g., TCP session termination, etc.). xFlow records are exported from the router using a transmission protocol and collected using an xFlow collector. A router conventionally does not store flow records once they are exported.

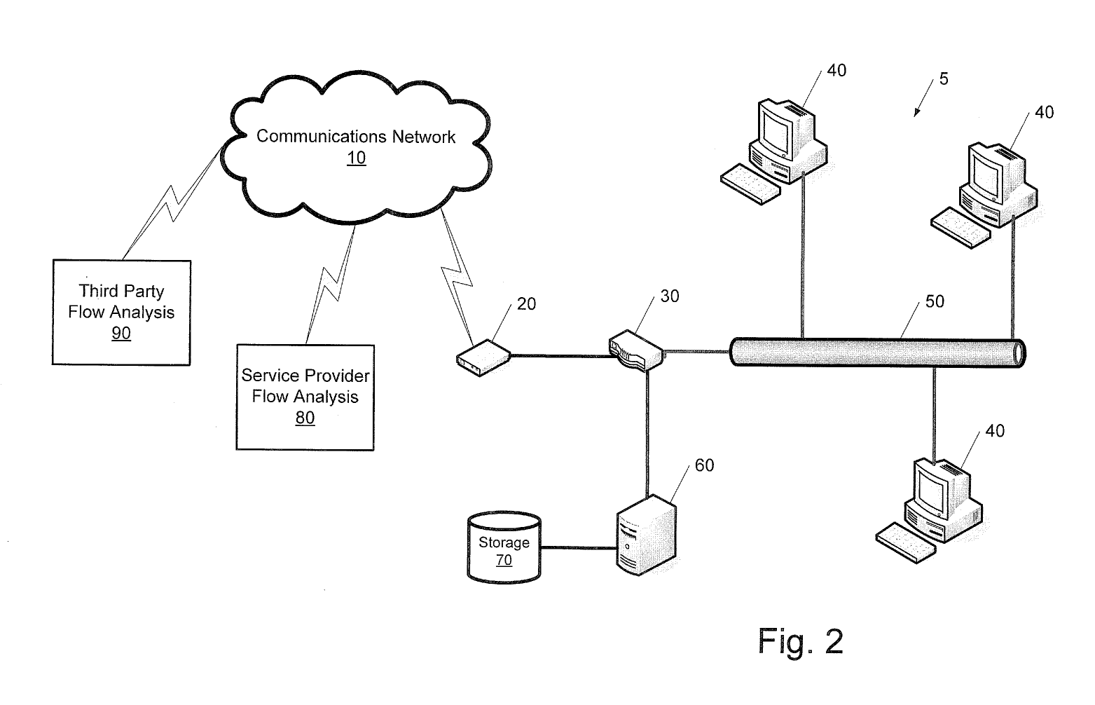

FIG. 2 illustrates an xFlow collector 60 added to the home/office network 5 of FIG. 1 and configured to communicate with the router in the residential gateway 30, according to some embodiments. The illustrated xFlow collector 60 also includes storage 70 (e.g., a database, etc.) for collected xFlow data. xFlow records can contain various information about a flow including, but not limited to, timestamps for the flow start and finish time, number of bytes and packets observed in the flow, source and destination IP addresses, source and destination port numbers, IP protocol, type of service (ToS) value, etc. Various other types of information may be included as well. The xFlow collector 60 analyzes the flow records received from the router to obtain a picture of traffic flow and traffic volume in the network 5. By collecting and analyzing the xFlow metadata, anomalous traffic can be identified and investigated. Upon the detection of anomalous traffic, further investigations can be used to determine whether malware resides on any computers 40 on the network 5, and remedial actions can be taken. This will enable the user and/or SP to take appropriate actions that will disrupt the botnet at the source (i.e., at one or more computers 40 on the network 5). For example, the SP may redirect a network connection for the private network 5 to a “walled garden” so as quarantine the network connection. The walled garden may also be used as a “repair depot” wherein one or more anti-malware scanners can be run so as to identify malware. In addition, an image of suspected malware can be obtained and forwarded to one or more anti-virus vendors.

According to some embodiments, the analysis of xFlow data can be performed remotely. For example, as illustrated in FIG. 2, the xFlow collector 60 can be configured to send collected xFlow data to an upstream service provider 80 or to a third party 90 for analysis. In other embodiments, the router can be configured to send xFlow data directly to an upstream service provider 80 or to a third party 90 for collection and analysis. In this case, a local xFlow data collector 60 is not required.

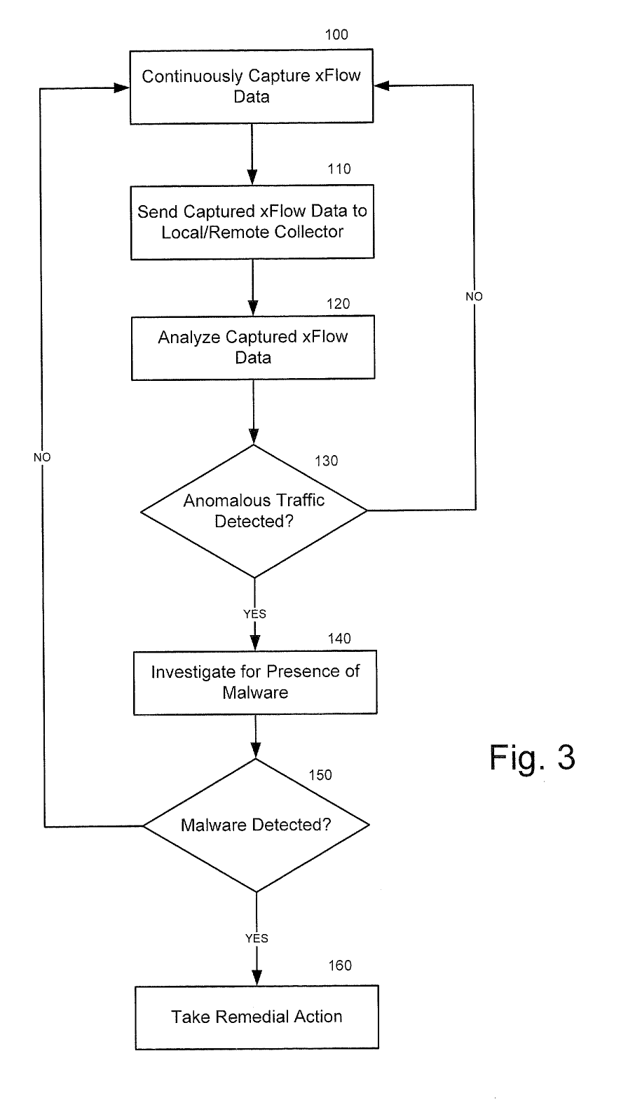

Referring now to FIG. 3, operations for monitoring and protecting home/small office networks from botnet and malware activity, according to some embodiments, are illustrated. xFlow data is continuously captured (Block 100) by a router (e.g., within gateway 30, FIG. 2) and directed to a local xFlow collector (60, FIG. 2) in some embodiments, or is directed to an upstream entity (e.g., a service provider 80 or third party 90, FIG. 2) in other embodiments (Block 110). The captured xFlow data is analyzed (Block 120) to determine the presence of anomalous traffic in the network 5. The analysis may involve the use of one or more activity profiling algorithms that are configured to detect anomalous traffic. Such activity profiling algorithms are configured to analyze xFlow data to detect activity that does not appear to be associated with normal activity of a user of a computer 40 on the network 5 (i.e., activity that appears to be abnormal for each particular user, etc.) or the way traffic looks on the composite network. If anomalous traffic is not detected (Block 130), no further operations occur; however, the router does continuously capture xFlow data (Block 100).

If anomalous traffic in the network is detected (Block 130), an investigation is conducted, locally and/or remotely (e.g., via a third party 90, via an SP 80, via xFlow collector 60), to determine whether malware is present on any of the computers 40 or other devices connected to the network 5 (Block 140). Determining whether malware is present on a device may include running anti-virus software and/or other malware detection software. Numerous tools exist for identifying malware and exemplary embodiments are not limited to any particular malware identification tools. For example, malware detection tools may be deployed to detect modified file names, modified registry entries, network connection attempts, use of specific ports and protocols such as IRC (Internet Relay Channel), HTTP (hypertext transfer protocol), and/or SMTP (simple mail transfer protocol) which are known to be used by malware, spam, etc. If malware is not detected (Block 150), no further operations occur and the router continues to capture xFlow data (Block 100).

If malware is detected (Block 150), remedial action is taken to remove or mitigate the malware (Block 160). Remedial action may be local action taken on the particular network 5, and/or may be performed remotely by a service provider. Local remedial action (Block 160) may be performed by anti-virus software or other malware detection software on a computer 40 on the network 5. Other software for removing and/or isolating detected malware can be utilized. Various other types of remedial actions may be taken, as well. For example, remedial action may include removing the malware from a computer 40, installing operating system patches to detect and eliminate the malware, reconfiguring browsers on computers 40 to block access to Internet sites suspected of being the source of detected malware, closing access to specific IRC, HTTP, SMTP ports, etc. Remote remedial action performed, for example, by a service provider, may include blocking access to certain web sites, redirecting a network connection into a walled garden, etc.

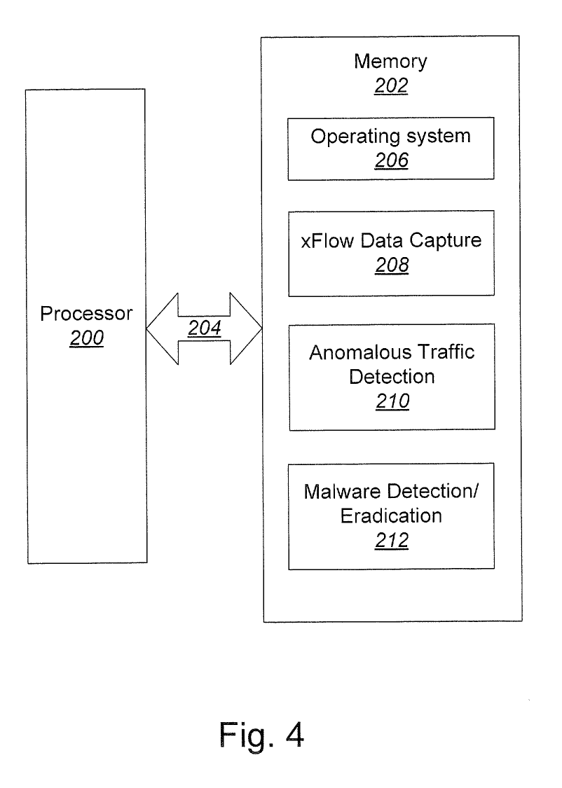

FIG. 4 illustrates an exemplary processor 200 and memory 202 that may be used by a local xFlow data collector (e.g., a local collector such as 60 illustrated in the network 5 of FIG. 2, or a remote device used by a service provider or other third party), for monitoring and protecting home/small office networks from botnet and malware activity, according to some embodiments. The processor 200 communicates with the memory 202 via an address/data bus 204. The processor 200 may be, for example, a commercially available or custom microprocessor. The memory 202 is representative of the overall hierarchy of memory devices containing the software and data used to implement a controller for monitoring for botnet and malware activity, in accordance with some embodiments. The memory 202 may include, but is not limited to, the following types of devices: cache, ROM, PROM, EPROM, EEPROM, flash, SPAM, and DRAM.

As shown in FIG. 4, the memory 202 may hold various categories of software and data: an operating system 206, an xFlow data capture module 208, an anomalous traffic detection module 210, and a malware detection/eradication module 212. The operating system 206 controls operations of the controller for monitoring for botnet and malware activity. In particular, the operating system 206 may manage the resources of the data collector and may coordinate execution of various programs (e.g., the xFlow data capture module 208, anomalous traffic detection module 210, malware detection/eradication module 212, etc.) by the processor 200.

The xFlow data capture module 208 comprises logic for communicating with the router of a network and capturing xFlow data from the router, as described above. The anomalous traffic detection module 210 comprises logic for executing activity profiling algorithms that are configured to detect anomalous traffic, as described above. The malware detection/eradication module 212 comprises logic for detecting the presence of malware and for removing or rendering the malware harmless, as described above.

Many variations and modifications can be made to the preferred embodiments without substantially departing from the principles of the present invention. All such variations and modifications are intended to be included herein within the scope of the present invention, as set forth in the following claims.

That which is claimed:

1. A method of protecting a private network from malware and botnet activity, wherein the private network is connected to a communications network, the method comprising:
collecting xFlow data associated with the private network;
analyzing the collected xFlow data to detect anomalous traffic on the private network; and
investigating the presence of malware on the private network in response to detecting anomalous traffic on the private network.

2. The method of claim 1, wherein collecting xFlow data comprises:
capturing xFlow data at a router that connects the private network to the communications network; and
sending the captured xFlow data to a local xFlow collector on the private network.

3. The method of claim 1, wherein collecting xFlow data comprises:
capturing xFlow data at a router that connects the private network to the communications network; and
sending the captured xFlow data to a remote xFlow collector connected to the communications network.

4. The method of claim 1, wherein analyzing collected xFlow data to detect anomalous traffic on the private network comprises applying one or more activity profiling algorithms to the xFlow data.

5. The method of claim 1, wherein investigating the presence of malware on the private network in response to detecting anomalous traffic on the private network comprises determining if a name of a file located on a computer on the private network has changed.

6. The method of claim 1, wherein investigating the presence of malware on the private network in response to detecting anomalous traffic on the private network comprises determining if a registry entry on a computer on the private network has been modified.

7. The method of claim 1, wherein investigating the presence of malware on the private network in response to detecting anomalous traffic on the private network comprises determining if one or more communications have occurred via specific IRC ports, HTTP ports, and/or SMTP ports.

8. The method of claim 1, wherein investigating the presence of malware on the private network in response to detecting anomalous traffic on the private network comprises determining if software on a computer on the private network has attempted one or more suspect and/or anomalous network connections.

9. The method of claim 1, further comprising redirecting the connection between the private network and the communications network to a quarantine area in response to detecting anomalous traffic on the private network.

10. An apparatus configured to protect a network from malware, comprising:
an xFlow data collector that collects xFlow data from the network; and
a processor and memory in communication with the xFlow data collector, wherein the processor and memory are configured to analyze collected xFlow data and detect anomalous traffic on the private network, and to investigate the presence of malware residing on one or more devices connected to the network in response to detecting anomalous traffic on the network.

11. The apparatus of claim 10, wherein the xFlow data collector is configured to collect xFlow data from a router associated with the network.

12. The apparatus of claim 10, wherein the processor is configured to apply one or more activity profiling algorithms to the xFlow data to detect anomalous traffic.

13. The apparatus of claim 10, wherein the processor is configured to determine if a name of a file located on a computer on the network has changed in response to detecting anomalous traffic on the network.

14. The apparatus of claim 10, wherein the processor is configured to determine if a registry entry on a computer on the network has been modified in response to detecting anomalous traffic on the network.

15. The apparatus of claim 10, wherein the processor is configured to determine if one or more communications have occurred via specific IRC ports, HTTP ports and/or SMTP ports in response to detecting anomalous traffic on the network.

16. The apparatus of claim 10, wherein the processor is configured to determine if software on a computer on the network has attempted one or more network connections in response to detecting anomalous traffic on the network.

17. The apparatus of claim 10, wherein the processor is configured to execute a malware eradication program that eradicates or isolates malware identified on a computer on the network.

18. A computer program product for protecting a private network from malware and botnet activity, wherein the private network is connected to a communications network, comprising a computer readable storage medium having encoded thereon instructions that, when executed on a computer, cause the computer to:
collect xFlow data associated with the private network;
analyze the collected xFlow data to detect anomalous traffic on the private network; and
investigate the presence of malware on the private network in response to detecting anomalous traffic on the private network.

19. The computer program product of claim 18, wherein the computer readable storage medium has encoded thereon instructions that, when executed on a computer, causes the computer to:
apply one or more activity profiling algorithms to the xFlow data.

20. The computer program product of claim 18, wherein the computer readable storage medium has encoded thereon instructions that, when executed on a computer, causes the computer to, in response to detecting anomalous traffic on the private network:
determine if a name of a file located on a computer on the private network has changed, determine if a registry entry on a computer on the private network has been modified, determine if one or more communications have occurred via specific IRC ports, HTTP ports and/or SMTP ports, and/or determine if software on a computer on the private network has attempted one or more network connections.
